(19) United States
(12) Patent Application Publication
(10) Pub. No.: US 2026/0197291 A1
(43) Pub. Date: Jul. 9, 2026

(54) METHOD CONFIGURED FOR NETWORK MANAGEMENT, COMPUTER DEVICE, AND COMPUTER-READABLE STORAGE MEDIUM

(71) Applicant: Fulian Precision Electronics (Tianjin) Co., LTD., Tianjin (CN)

(72) Inventors: HSIAO-WEN TSAI, New Taipei (TW); SHENG-CHUNG PAN, New Taipei (TW)

(21) Appl. No.: 19/220,617

(22) Filed: May 28, 2025

(30) Foreign Application Priority Data
Jan. 3, 2025 (CN) 202510008532.8

(51) Int. Cl. H04L 61/103; H04L 12/46; H04L 61/5014; H04L 101/622

(52) U.S. Cl. CPC H04L 61/103; H04L 12/4641; H04L 61/5014; H04L 2101/622

(57) ABSTRACT

A method configured for network management is provided. The method comprising: obtaining an ARP table and a MAC table in a network environment, wherein the ARP table stores a mapping relationship between IP addresses and MAC addresses, and the MAC table stores a mapping relationship between VLAN IDs, MAC addresses, and switch ports; determining a mapping relationship among IP addresses, VLAN IDs, MAC addresses, and switch ports based on the ARP table and the MAC table; and when the network environment changes, disabling a target switch port, or assigning an isolated VLAN ID to the target switch port, wherein the target switch port is a switch port where a change occurs, or a switch port corresponding to a changed IP address or MAC address.

### CROSS-REFERENCE TO RELATED APPLICATIONS

This application claims priority to Chinese Patent Application No. 202510008532.8 filed on Jan. 3, 2025, in China National Intellectual Property Administration, the contents of which are incorporated by reference herein.

### FIELD

The subject matter herein generally relates to computer network technology field, and more particularly to method configured for network management, computer device, and computer-readable storage medium.

### BACKGROUND

A network management system typically relies on a dynamic host configuration protocol (DHCP) Option 82 function to track and manage internet protocol (IP) addresses of access devices. The DHCP Option 82 function enables the embedding of location information within DHCP messages. The location information includes switch ports and virtual local area network (VLAN) IDs corresponding to the access devices, such that facilitating network administrators in precisely locating the access devices. The DHCP Option 82 function generally requires both DHCP servers and switches to support the DHCP Option 82 configuration. Additionally, The DHCP Option 82 function involves configuring parameters of the DHCP servers and the switches to parse and store the location information. However, not all switches support DHCP Option 82 configuration, and the processes of configuring the parameters of the DHCP servers and the switches are rather intricate, resulting in elevated network maintenance costs.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of a method configured for network management provided by an embodiment of the present disclosure.

FIG. 2 is a diagram of a MAC table provided by an embodiment of the present disclosure.

FIG. 3 is a diagram of an ARP table provided by an embodiment of the present disclosure.

FIG. 4 is a diagram of displaying duplicate IPs provided by an embodiment of the present disclosure.

FIG. 5 is a diagram of displaying MAC addresses corresponding to the duplicate IPs provided by an embodiment of the present disclosure.

FIG. 6 is a structure diagram of a network management system provided by an embodiment of the present disclosure.

FIG. 7 is a structure diagram of a network management system provided by another embodiment of the present disclosure.

FIG. 8 is a structure diagram of a network management system provided by another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

In the embodiments of the present disclosure, computer devices and access devices include, but are not limited to, desktop computers, tablet computers, palmtop computers, laptop computers, smart phones, intelligent robots, unmanned aerial vehicles, mobile internet devices (MIDs), virtual reality (VR) devices, augmented reality (AR) devices, wireless terminals in industrial control, wireless terminals in self-driving, wireless terminals in remote medical surgery, wireless terminals in smart grids, wireless terminals in transportation safety, wireless terminals in smart cities, wireless terminals in smart homes, cellular phones, cordless phones, session initiation protocol (SIP) phones, wireless local loop (WLL) stations, personal digital assistants (PDAs), handheld devices with wireless communication functions, in-vehicle devices, wearable devices, terminal devices in 5G networks, or terminal devices in public land mobile networks (PLMNs).

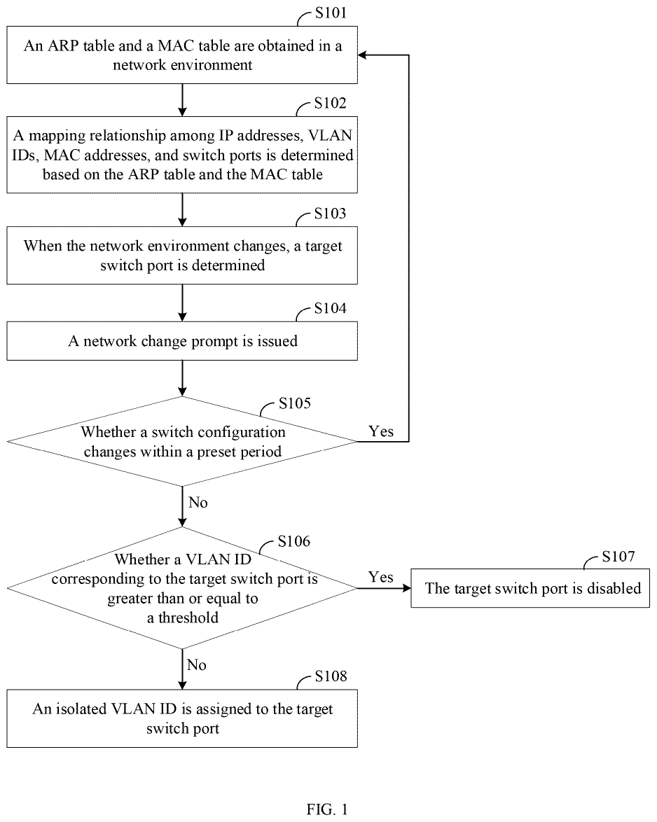

FIG. 1 is a flowchart of a method configured for network management. As shown in FIG. 1, the method includes the following blocks.

At block S101, an address resolution protocol (ARP) table and a media access control (MAC) table are obtained in a network environment.

In block S101, the ARP table stores a mapping relationship between IP addresses and MAC addresses, and the MAC table stores a mapping relationship between VLAN IDs, MAC addresses, and switch ports.

In block S101, the ARP table is stored in a DHCP server, and the MAC table is stored in a switch. The ARP table is obtained by requesting the ARP table from the DHCP server. The MAC table is obtained by requesting the MAC table from the switch.

At block S102, a mapping relationship among IP addresses, VLAN IDs, MAC addresses, and switch ports is determined based on the ARP table and the MAC table.

At block S103, when the network environment changes, a target switch port is determined.

In block S103, detecting a change of the network environment comprising: changing of the IP addresses, changing of the MAC addresses, changing of the switch ports, changing of an expiration of a DHCP lease, changing of an unauthorized DHCP service, and changing of a MAC address not listed in the MAC table.

In block S103, the target switch port is a switch port where a change occurs, or a switch port corresponding to a changed IP address or MAC address.

At block S104, a network change prompt is issued.

In block S104, the network change prompt is configured to prompt at least one reason for a change in the network environment. The at least one reason includes changing of the IP addresses, changing of the MAC addresses, changing of the switch ports, changing of an expiration of a DHCP lease, changing of an unauthorized DHCP service, and changing of a MAC address not listed in the MAC table.

At block S105, whether a switch configuration changes within a preset period.

In this embodiment, when the switch configuration changes within the preset period, block S101 is implemented. And when the switch configuration is unchanged within the preset period, block S106 is implemented.

In block S105, network administrators may change configuration parameters of a switch, resulting in a change in the switch configuration after the network change prompt is issued.

At block S106, whether a VLAN ID of the network environment corresponding to the target switch port is greater than or equal to a threshold.

In this embodiment, when the VLAN ID of the network environment corresponding to the target switch port is greater than or equal to the threshold, block S107 is implemented. And when the VLAN ID of the network environment corresponding to the target switch port is less than the threshold, block S108 is implemented.

At block S107, the target switch port is disabled.

At block S108, an isolated VLAN ID is assigned to the target switch port.

In this embodiment, accurate positioning of access devices connected to switch ports are achieved according to the mapping relationship among IP addresses, VLAN IDs, MAC addresses, and switch ports. When the network environment changes, the target switch port is determined and the network change prompt is issued, such that timely notifying network administrators of a change in the network environment. When a VLAN ID of the network environment corresponding to the target switch port is greater than or equal to the threshold, the target switch port is disabled; and when the VLAN ID of the network environment corresponding to the target switch port is less than the threshold, an isolated VLAN ID is assigned to the target switch port, such that VLAN resource consumption is reduced and network security is enhanced. Furthermore, due to not relying on the DHCP Option 82 function, the hardware configuration requirements for DHCP servers and switches are reduced, such that network maintenance costs are reduced, and network applicability is enhanced.

The following description briefly describes the method for network management in a scenario of detecting an unauthorized DHCP service.

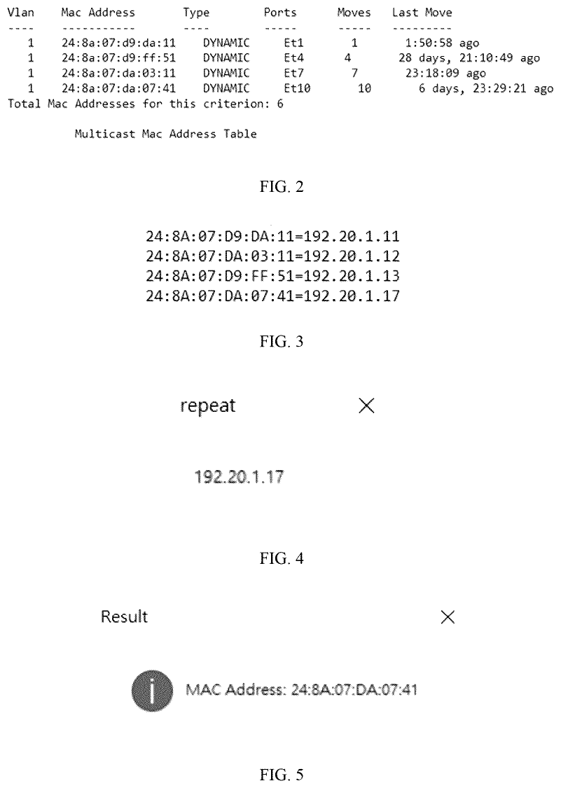

As shown in FIG. 2, a MAC table is obtained, which includes a mapping relationship between VLAN IDs, MAC addresses, and switch ports. As shown in FIG. 3, an ARP table is obtained, which includes a mapping relationship between IP addresses and MAC addresses. As shown in FIG. 4, when a duplicate IP address is detected, an unauthorized DHCP service is determined, and the duplicate IP address is displayed. As shown in FIG. 5, the MAC address corresponding to the duplicate IP address is determined according to a mapping relationship among IP addresses, VLAN IDs, MAC addresses, and switch ports, and the MAC address corresponding to the duplicate IP address is displayed, such that an illegal device is accurately located.

The following description specifically describes network management systems provided by the embodiments of the present disclosure.

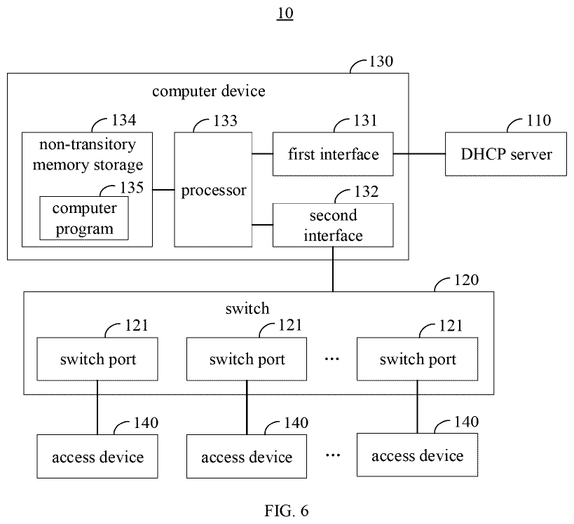

FIG. 6 is a structure diagram of a network management system. As shown in FIG. 6, the network management system 10 includes a DHCP server 110, a switch 120, a computer device 130, and at least one access device 140.

The DHCP server 110 stores an ARP table, the ARP table stores a mapping relationship between IP addresses and MAC addresses.

The switch 120 includes at least one switch port 121. The at least one switch port 121 is configured to connect to the at least one access device 140. The switch 120 stores a MAC table, the MAC table stores a mapping relationship between VLAN IDs, MAC addresses, and the at least one switch port 121.

The computer device 130 includes a first interface 131, a second interface 132, a processor 133, a non-transitory memory storage 134, and a computer program 135. The first interface 131 is configured to connect to the DHCP server 110. The second interface 132 is configured to connect to the switch 120. The processor 133 is electrically connected to the first interface 131 and the second interface 132. The non-transitory memory storage 134 coupled with the processor 133. The computer program 135 is stored in the non-transitory memory storage 134, which when executed by the processor 133 to achieve the method described above.

In an embodiment, the processor 133 sends an ARP table request to the DHCP server 110 through the first interface 131, and sends a MAC table request to the switch 120 through the second interface 132. The DHCP server 110 responds to the ARP table request, and sends the ARP table to the computer device 130. The switch 120 responds to the MAC table request, and sends the MAC table to the computer device 130. The processor 133 receives the ARP table from the DHCP server 110 through the first interface 131, and receives the MAC table from the switch 120 through the second interface 132. The processor 133 determines a mapping relationship among IP addresses, VLAN IDs, MAC addresses, and the at least one switch port 121 based on the ARP table and the MAC table, such that achieving accurate positioning of the at least one access device 140 connected to the at least one switch port 121.

When the processor 133 detects a change of the network environment, the processor 133 determines a target switch port and issues a network change prompt, such that timely notifying network administrators of the change in the network environment. The target switch port is a switch port where a change occurs, or a switch port corresponding to a changed IP address or MAC address.

In this embodiment, a change of the network environment comprises: changing of the IP addresses, changing of the MAC addresses, changing of the at least one switch port 121, changing of an expiration of a DHCP lease, changing of an unauthorized DHCP service, and changing of a MAC address not listed in the MAC table.

The DHCP server 110 records the DHCP lease corresponding to an IP address when allocating the IP address. When the DHCP lease corresponding to an IP address expires, the IP address becomes invalid.

The unauthorized DHCP service includes an IP address assigned to an unauthorized access device by a rogue DHCP server. The unauthorized access device refers to an access device that has not been authenticated by the switch 120, that is, an illegal device.

In this embodiment, the network change prompt is configured to prompt at least one reason for the network change. The at least one reason for the network change includes changing of the IP addresses, changing of the MAC addresses, changing of the at least one switch port 121, changing of an expiration of a DHCP lease, changing of an unauthorized DHCP service, and changing of a MAC address not listed in the MAC table.

In this embodiment, after the processor 133 issues the network change prompt, when the processor 133 does not detect a change in the configuration of the switch 120 within a preset period, the processor 133 disables the target switch port or assigns an isolated VLAN ID to the target switch port, such that network security is enhanced.

In this embodiment, the processor 133 disables the target switch port or assigns an isolated VLAN ID to the target switch port including: when a VLAN ID of the network environment corresponding to the target switch port is greater than or equal to a threshold, disabling the target switch port; when the VLAN ID of the network environment corresponding to the target switch port is less than the threshold, assigning an isolated VLAN ID to the target switch port. Wherein the threshold may be set as desired.

In this embodiment, the computer device 130 serves as a management core of the network management system 10. In other embodiments, a DHCP server or a switch may also serve as a management core of a network management system.

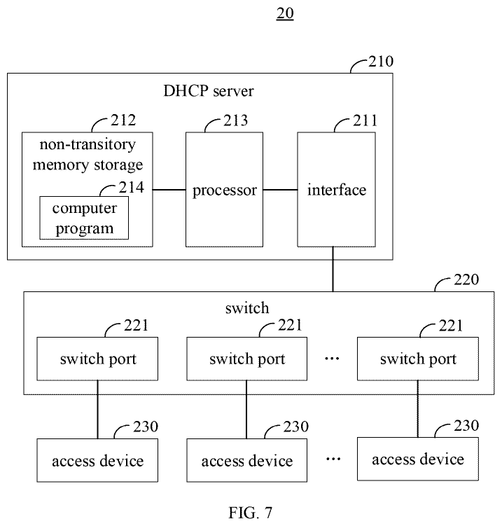

As shown in FIG. 7, the network management system 20 includes a DHCP server 210, a switch 220, and at least one access device 230.

The DHCP server 210 includes an interface 211, a non-transitory memory storage 212, a processor 213, and a computer program 214. The interface 211 is configured to connect to the switch 220. The non-transitory memory storage 212 is coupled with the processor 213, and the non-transitory memory storage 212 stores an ARP table. The processor 213 is electrically connected to the interface 211. The computer program 214 is stored in the non-transitory memory storage 212, which when executed by the processor 213 to achieve the method described above.

In an embodiment, the processor 213 sends a MAC table request to the switch 220 through the interface 211. The switch 220 responds to the MAC table request, and sends a MAC table to the DHCP server 210. The processor 213 receives the MAC table from the switch 120 through the interface 211. The processor 213 determines a mapping relationship among IP addresses, VLAN IDs, MAC addresses, and at least one switch port 221 based on the MAC table and the ARP table stored in the memory 212, such that achieving accurate positioning of the at least one access device 230 connected to the at least one switch port 221.

In this embodiment, the DHCP server 210 serves as a management core of the network management system 20. The following description briefly describes a scenario where a switch serves as a management core of a network management system.

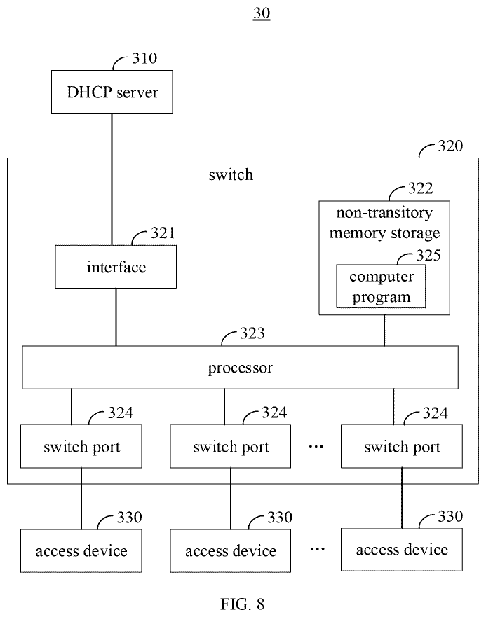

As shown in FIG. 8, the network management system 30 includes a DHCP server 310, a switch 320, and at least one access device 330.

The DHCP server 310 stores an ARP table.

The switch 320 includes an interface 321, a non-transitory memory storage 322, a processor 323, at least one switch port 324, and a computer program 325. The interface 321 is configured to connect to the DHCP server 310. The processor 323 is electrically connected to the interface 321 and the at least one switch port 324. The at least one switch port 324 is configured to connect to the at least one access device 330. The non-transitory memory storage 322 is coupled with the processor 323, and the non-transitory memory storage 322 stores a MAC table. The computer program 325 is stored in the non-transitory memory storage 322, which when executed by the processor 323 to achieve the method described above.

In an embodiment, the processor 323 sends an ARP table request to the DHCP server 310 through the interface 321. The DHCP server 310 responds to the ARP table request, and sends an ARP table to the switch 320. The processor 323 receives the ARP table from the DHCP server 310 through the interface 321. The processor 323 determines a mapping relationship among IP addresses, VLAN IDs, MAC addresses, and the at least one switch port 324 based on the ARP table and the MAC table stored in the memory 322, such that achieving accurate positioning of the at least one access device 330 connected to the at least one switch port 324.

In the present disclosure, a processor may be, but is not limited to, a central processing unit (CPU), a general-purpose processor, a digital signal processor (DSP), an application-specific integrated circuit (ASIC), a field-programmable gate array (FPGA) or another programmable logic device, a discrete gate or transistor logic device, a discrete hardware component. The general-purpose processor may be a microprocessor or any conventional processor.

A non-transitory memory storage may be an internal storage unit, such as a hard disk. In other embodiments, the non-transitory memory storage may also be an external storage device, such as a plug-in hard disk, a smart memory card (SMC), a secure digital (SD) card, a flash card. Further, the non-transitory memory storage may also include both an internal storage unit and an external storage device. The non-transitory memory storage is configured to store an operating system, a disclosure program, and other programs, such as a program code of a computer program. The non-transitory memory storage may also be configured to temporarily store data that has been output or is to be output.

The present disclosure further provides a computer-readable storage medium, the computer-readable storage medium is configured to store a computer program. The computer program may be executed by a processor to achieve the method described above, which is not repeated here.

The computer-readable medium may include a read-only memory (ROM), a random access memory (RAM), a USB flash drive, a mobile hard disk, a magnetic disk or an optical disk.

The above description only describes embodiments of the present disclosure, and is not intended to limit the present disclosure, various modifications and changes can be made to the present disclosure. Any modifications, equivalent substitutions, improvements, etc. made in the spirit and scope of the present disclosure are intended to be included in the scope of the present disclosure.

What is claimed is:

1. A method configured for network management, comprising:
obtaining an ARP table and a MAC table in a network environment, wherein the ARP table stores a mapping relationship between IP addresses and MAC addresses, and the MAC table stores a mapping relationship between VLAN IDs, MAC addresses, and switch ports;
determining a mapping relationship among IP addresses, VLAN IDs, MAC addresses, and switch ports based on the ARP table and the MAC table; and
when the network environment changes, disabling a target switch port, or assigning an isolated VLAN ID to the target switch port, wherein the target switch port is a switch port where a change occurs, or a switch port corresponding to a changed IP address or MAC address.

2. The method of claim 1, when the network environment changes, disabling a target switch port, or assigning an isolated VLAN ID to the target switch port comprising:
when a VLAN ID of the network environment corresponding to the target switch port is greater than or equal to a threshold, disabling the target switch port; and
when the VLAN ID of the network environment corresponding to the target switch port is less than the threshold, assigning the isolated VLAN ID to the target switch port.

3. The method of claim 1, when the network environment changes, disabling a target switch port, or assigning an isolated VLAN ID to the target switch port comprising:
when detecting a change of the network environment comprises: changing of the IP addresses, changing of the MAC addresses, changing of the switch ports, changing of an expiration of a DHCP lease, changing of an unauthorized DHCP service, and changing of a MAC address not listed in the MAC table, disabling the target switch port, or assigning the isolated VLAN ID to the target switch port.

4. The method of claim 3, wherein the unauthorized DHCP service comprising:
an IP address assigned to an unauthorized access device by a rogue DHCP server.

5. The method of claim 1, further comprising:
when the network environment changes, issuing a network change prompt, wherein the network change prompt is configured to prompt at least one reason for a change in the network environment.

6. The method of claim 5, wherein the at least one reason comprising:
changing of the IP addresses, changing of the MAC addresses, changing of the switch ports, changing of an expiration of a DHCP lease, changing of an unauthorized DHCP service, and changing of a MAC address not listed in the MAC table.

7. The method of claim 1, wherein obtaining an ARP table and a MAC table in a network environment comprising:
requesting the ARP table from a DHCP server; and
requesting the MAC table from a switch.

8. A computer device, comprising:
at least one processor;
a non-transitory memory storage, coupled with the at least one processor; and
a computer program stored in the non-transitory memory storage, which when executed by the at least one processor to:
obtain an ARP table and a MAC table in a network environment, wherein the ARP table stores a mapping relationship between IP addresses and MAC addresses, and the MAC table stores a mapping relationship between VLAN IDs, MAC addresses, and switch ports;
determine a mapping relationship among IP addresses, VLAN IDs, MAC addresses, and switch ports based on the ARP table and the MAC table; and
when the network environment changes, disable a target switch port, or assign an isolated VLAN ID to the target switch port, wherein the target switch port is a switch port where a change occurs, or a switch port corresponding to a changed IP address or MAC address.

9. The computer device of claim 8, when the network environment changes, disabling a target switch port, or assigning an isolated VLAN ID to the target switch port comprising:
when a VLAN ID of the network environment corresponding to the target switch port is greater than or equal to a threshold, disabling the target switch port; and
when the VLAN ID of the network environment corresponding to the target switch port is less than the threshold, assigning the isolated VLAN ID to the target switch port.

10. The computer device of claim 8, when the network environment changes, disabling a target switch port, or assigning an isolated VLAN ID to the target switch port comprising:
when detecting a change of the network environment comprises: changing of the IP addresses, changing of the MAC addresses, changing of the switch ports, changing of an expiration of a DHCP lease, changing of an unauthorized DHCP service, and changing of a MAC address not listed in the MAC table, disabling the target switch port, or assigning the isolated VLAN ID to the target switch port.

11. The computer device of claim 10, wherein the unauthorized DHCP service comprising:
an IP address assigned to an unauthorized access device by a rogue DHCP server.

12. The computer device of claim 8, further configured to:
when the network environment changes, issue a network change prompt, wherein the network change prompt is configured to prompt at least one reason for a change in the network environment.

13. The computer device of claim 12, wherein the at least one reason comprising:
changing of the IP addresses, changing of the MAC addresses, changing of the switch ports, changing of an expiration of a DHCP lease, changing of an unauthorized DHCP service, and changing of a MAC address not listed in the MAC table.

14. The computer device of claim 8, wherein obtaining an ARP table and a MAC table in a network environment comprising:
requesting the ARP table from a DHCP server; and
requesting the MAC table from a switch.

15. A computer-readable storage medium, configured to store a computer program, the computer program may be executed by a processor to:
obtain an ARP table and a MAC table in a network environment, wherein the ARP table stores a mapping relationship between IP addresses and MAC addresses, and the MAC table stores a mapping relationship between VLAN IDs, MAC addresses, and switch ports;
determine a mapping relationship among IP addresses, VLAN IDs, MAC addresses, and switch ports based on the ARP table and the MAC table; and
when the network environment changes, disable a target switch port, or assign an isolated VLAN ID to the target switch port, wherein the target switch port is a switch port where a change occurs, or a switch port corresponding to a changed IP address or MAC address.

16. The computer-readable storage medium of claim 15, when the network environment changes, disabling a target switch port, or assigning an isolated VLAN ID to the target switch port comprising:
when a VLAN ID of the network environment corresponding to the target switch port is greater than or equal to a threshold, disabling the target switch port; and
when the VLAN ID of the network environment corresponding to the target switch port is less than the threshold, assigning the isolated VLAN ID to the target switch port.

17. The computer-readable storage medium of claim 15, when the network environment changes, disabling a target switch port, or assigning an isolated VLAN ID to the target switch port comprising:
when detecting a change of the network environment comprises: changing of the IP addresses, changing of the MAC addresses, changing of the switch ports, changing of an expiration of a DHCP lease, changing of an unauthorized DHCP service, and changing of a MAC address not listed in the MAC table, disabling the target switch port, or assigning the isolated VLAN ID to the target switch port.

18. The computer-readable storage medium of claim 17, wherein the unauthorized DHCP service comprising:
an IP address assigned to an unauthorized access device by a rogue DHCP server.

19. The computer-readable storage medium of claim 15, further configured to:
when the network environment changes, issue a network change prompt, wherein the network change prompt is configured to prompt at least one reason for a change in the network environment.

20. The computer-readable storage medium of claim 19, wherein the at least one reason comprising:
changing of the IP addresses, changing of the MAC addresses, changing of the switch ports, changing of an expiration of a DHCP lease, changing of an unauthorized DHCP service, and changing of a MAC address not listed in the MAC table.
